(19) United States
(12) Patent Application Publication
(10) Pub. No.: US 2002/0178056 A1
(43) Pub. Date: Nov. 28, 2002

(54) Consumer loyalty marketing program based on multi-transaction platform that provides high rewards to members under a tiered reward scheme

(76) Inventor: Chee Beng Lim, Ampang (MY)

Correspondence Address: MARTINE & PENILLA, LLP, 710 LAKEWAY DRIVE, SUITE 170, SUNNYVALE, CA, 94085, US

(21) Appl. No.: 09/975,484

(22) Filed: Oct. 10, 2001

(30) Foreign Application Priority Data
Mar. 30, 2001 (MY) PI 2001 1529

(51) Int. Cl. G06F 17/60

(52) U.S. Cl. 705/14

(57) ABSTRACT

According to the invention, a customer loyalty marketing program is based on a multi-transaction platform that provides high rewards to member consumers under a tiered reward scheme. The invention includes the steps of registering a member consumer and creating a member record in a computer server; registering a member merchant outlet and creating a member merchant record; recording all transactions made by member consumers in a transaction record; issuing loyalty numbers to member consumers following their individual levels of spending according to pre-determined rules of the program; randomly selecting at least one potential reward recipient from a database of participating members, when a target is reached according to pre-determined rules of the program; answering a quiz correctly to claim and receive the rewards from the tiered reward scheme on an optional basis; and updating all records therein the computer server after each selection of the program.

### TECHNICAL FIELD

The present invention relates generally to consumer loyalty marketing programs. Particularly, the present invention relates to a computerized method and system, which generates, communicates and manages a tiered reward scheme to its members, the reward being many times more than the amount any member consumer has spent within a program period.

### BACKGROUND ART

Computerized methods and systems for promoting consumer loyalty are well known. These methods and systems are generally designed to reward a member for exhibiting certain behavior preferred by a loyalty program operator. The reward programs are either one of the following three categories, namely reward accrual programs, tiered reward programs and specialty programs.

In reward accrual programs, the rewards are usually only of a very small monetary value or a very small fraction (such as 1%) of the value of total transactions carried out during a time period. The rewards take the form of accrued (loyalty) points, which are later redeemed, whence an eligible member of a loyalty marketing program buys a similar line of products or services from the operator of the loyalty program. The program is often limited to a geographic location or to a limited group of special consumers (such as frequent flier). They are therefore limited in value or appeal.

A system and method for administering a tiered reward program is disclosed in the U.S. Pat. No. 5,025,372 by Burton et. al. This patent describes a system for processing and distributing rewards based on a participant's achieving a predefined level of performance. The predefined performance levels are selected by a sponsoring company and the rewards are limited to credits to the cardholders's account.

The U.S. Pat. No. 6,018,718 discloses a method for providing and managing a customized reward offer to a holder of a financial account. The method includes the steps of accessing historical account data associated with the financial account, determining a first performance target associated with the financial account, selecting a reward offer having an associated reward description, transmitting the first performance target and the reward description to the account holder, collecting transaction data associated with the financial account, evaluating the collected transaction data to determine a second performance target associated with the financial account, and comparing the collected transaction data with said first performance target. If the collected transaction data exceeds the first performance target, the financial account is updated to reflect the reward.

Although tiered reward programs encourage a consumer or cardholder to spend more or perform at a higher level, there are significant shortcomings. A first shortcoming is that the rewards are predetermined for the entire population of participating cardholders or consumers. A cardholder or consumer who is not interested in the offered rewards will not be motivated to perform at a higher level. Another shortcoming of tiered reward programs is that they encourage the same type of activity for every cardholder without regard to the consumers' other needs and purchasing patterns.

Specialty programs are tailored to a particular group of cardholders who conforms to certain behaviors identified by the program operator. Again, loyalty points are issued and they are later redeemed. Such specialty programs have similar shortcomings to the accrual and tiered reward programs described above.

All existing loyalty marketing programs require a member to spend within a time period such as one year. In return, the member receives a reward equal in value to approximately 1% of total spending. Members, with a lot of spending power, are not interested in such a small reward. On the other hand, some members, who are attracted by the rewards, may not have the required spending power to claim the attractive rewards and more valuable rewards. They could not spend enough to claim the reward.

### SUMMARY OF THE INVENTION

A primary object of the invention is to give equal opportunities to all members of a consumer loyalty marketing program to compete for a loyalty reward, where the value of the reward is many times larger than the total transaction value any individual member may have spent under a program.

A second object of the invention is to introduce a tiered scheme to the above-mentioned program, where there may be more than one prize or reward for each program.

A third object of the invention is to randomly select a reward recipient by computer or manually, with or without having to answer a quiz correctly.

Another object of the invention is that the reward is awarded in monetary value or in kind.

Yet, another object of the invention is to carry forward the opportunities of a present program to subsequent programs, where a few programs are run in a series.

Yet, another object of the invention is that the consumer loyalty marketing program can be operated on a global basis.

Accordingly, a consumer loyalty marketing program based on a multi-transaction platform that provides high rewards to member consumers under a tiered reward scheme, involving electronic input means, a computer server, member consumers, member merchant outlets and a program operator, comprises the steps of:

registering a member consumer and creating a member record in a computer server;

registering a member merchant outlet and creating a member merchant record;

recording all transactions made by member consumers in a transaction record;

issuing loyalty numbers to member consumers following their individual levels of spending according to predetermined rules of the program;

randomly selecting at least one potential reward recipient from a database of participating member consumers, when a target is reached according to pre-determined rules of the program;

answering a quiz correctly to claim and receive the rewards from the tiered reward scheme on an optional basis; and

updating all records therein the computer server after each selection of the program.

The random selection for each program can be computer-generated or manually generated.

There can be more than one prize reward in each program. A few programs can be run in a series. At the end of the series, the loyalty numbers are rendered null and void.

### BRIEF DESCRIPTION OF THE DRAWINGS

The above objects and other features will become apparent from the detailed description below, when read in connection with the accompanying drawings.

FIG. 1 shows one example of system architecture to implement the invention.

FIG. 2 shows a workflow of the invention.

### DETAILED DESCRIPTION

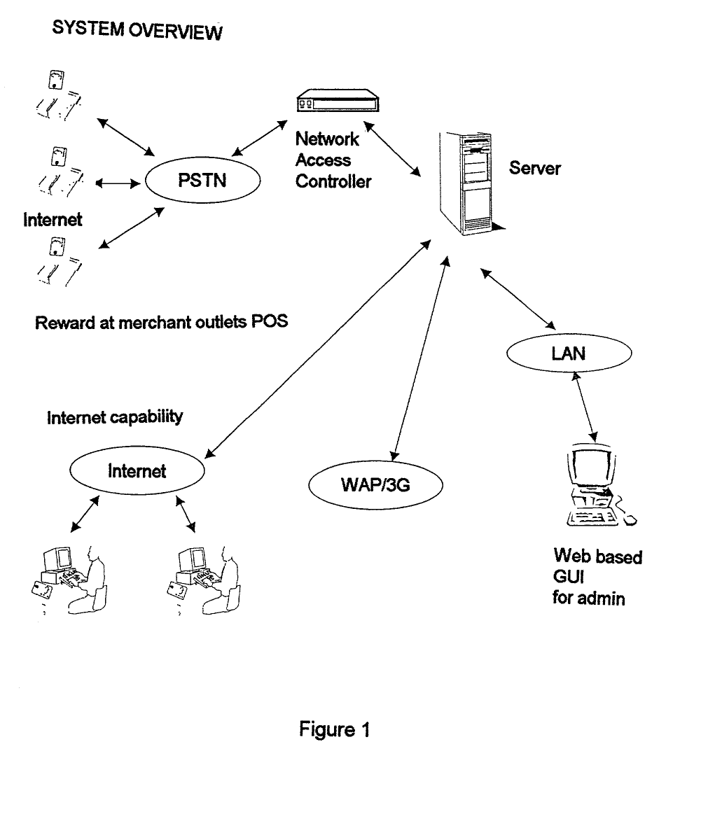

As seen in FIG. 1, the invention is served by a central computer system, which operates the invention. A member consumer can make a transaction on a global basis, preferably using whatever electronic point of sales (POS) means, such as cash, credit card, debit card, internet, WAP, LAN and so on. The input information will be entered into the computer server. Additionally, the invention can be activated at any member merchant outlet, in any country, using any transaction platform such as cash, cheque, money order, and so on. The purchase particulars are either automatically or manually keyed into the computer system operating the invention.

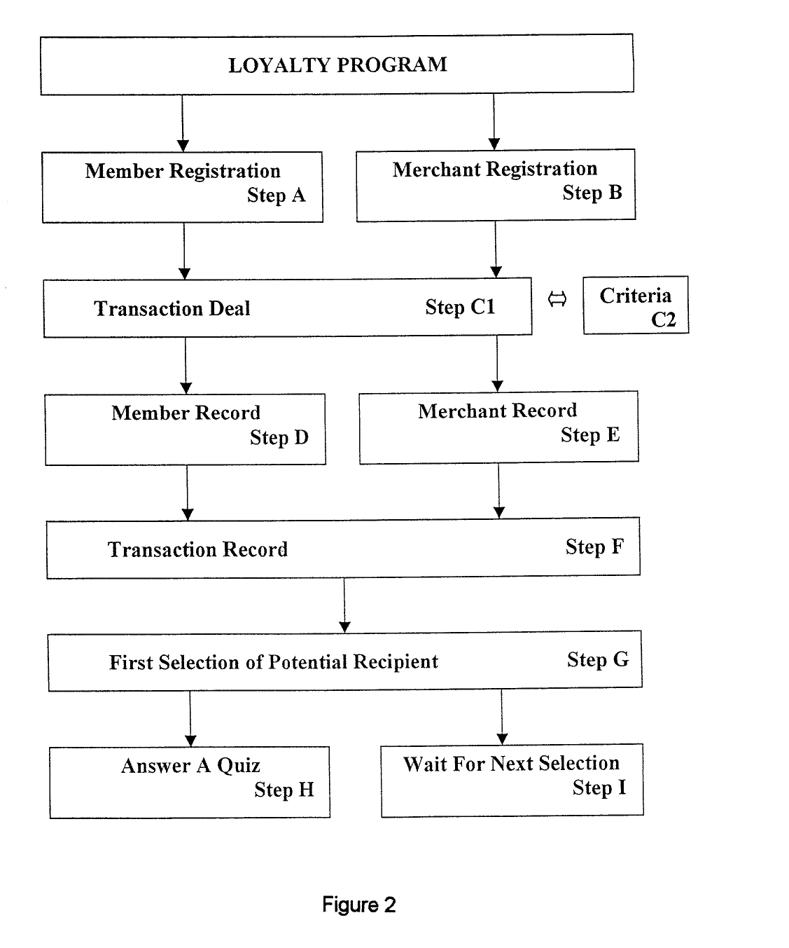

FIG. 2 illustrates the essential steps outlining the workflow of the invention.

In Step A, a member consumer is registered and a member record created in a computer server. A member of the public subscribes to a consumer loyalty marketing program in accordance to the teaching of the present invention. His or her personal particulars are registered in a central database. The particulars include the following:

Photographic image

Surname

First name

Address

Email

Expiry date

Membership number

Credit card number

Password

Personal Identity (ID) or Personal Identification Number (PIN)

And other particulars deemed necessary to describe the member.

The member consumer is then issued a membership card in the form of a magnetic strip card or a smart card with an embedded chip. A financial account in the form of a member record is raised and maintained in the server.

In Step B, a member merchant outlet is registered and a member merchant record created. A merchant applies to be registered with the loyalty program. The merchant includes B & M merchant, eCommerce merchant, mobile commerce merchant or any other types of merchant retailer, or service provider.

The merchant outlet particulars include the following:

Company Name

Contact Surname

First name

Address

Email

Expiry date

Merchant Outlet Identification Number

Password

Personal Identity (ID) or Personal Identification Number (PIN)

And other particulars deemed necessary from time to time.

In Step C1, all transactions made by member consumers are recorded in a transaction record. A member consumer of the loyalty program makes a purchase at any member merchant outlet. His identification is verified. The value of the transaction is entered into the computer system and his financial account is then updated.

In Step C2, loyalty numbers are issued to member consumers following their individual levels of spending according to pre-determined rules of the program. Based on predetermined criteria and formula, the loyalty program automatically calculates the amount of the rebates to be paid by the member merchant outlet, as well as the loyalty number(s) to be awarded to the member consumer.

The loyalty program operator determines firstly a percentage of the rebate is to be given by or received from the member merchant outlet. The operator then decides on another percentage of the cumulative rebates in total, such as 50% of the total rebates, which contributes to the reward prize at each selection. The rebate scheme can vary for each member merchant outlet. For an example, at a certain member merchant outlet, a purchase of $50 qualifies for 1% rebate and $200 qualifies for 1.5% rebate and so on. Additionally, a purchase of $50 qualifies for 1% rebate at merchant outlet A, but a purchase of $50 qualifies for 2% rebate at merchant outlet B. The program also allows different conditions to be applied. For an example, where the purchase value is transacted via the internet or any other communication network using magnetic or smart card reader, the loyalty program can calculate an appropriate rebate that the member merchant has agreed to give.

For the ease of explanation, the transaction value is expressed in dollars. It is to be understood that the transaction can also be operated in local currencies with appropriate exchange schemes, when the program is operated globally.

Loyalty numbers are issued by the computer system automatically to eligible members. The quantum of loyalty numbers issued depends on certain pre-determined rules. For every transaction, the server system computes the value of a transaction and awards the member with an appropriate quantum of loyalty numbers, according to the rules. If the transaction value meets a predetermined basic criterion, an award of loyalty numbers is made. For an example, one loyalty number is awarded for every transaction value between $10 and $100. Alternatively, one loyalty number is awarded for every transaction value of $50. If the transaction value meets a second criterion, a second award can also be offered. For an example, a second loyalty number is awarded for every transaction between $101 and $500. If the transaction value meets other criteria, other award is offered, such as a third loyalty number is offered for any transaction above $501.

In Step D, each member consumer record in the database will carry information, such as the transaction value, the member merchant outlet ID, the rebate to be given, and the loyalty numbers as generated by the loyalty program. For illustration, an example of a member record is shown below:—

| Item | Date | Merchant ID | Transaction Value | Loyalty No (s). | Received |
|---|---|---|---|---|---|
| 1 | 03/03/2001 | MY123456 | $250.00 | 1234 4567 7891 1234 | Yes |
| 2 | 04/03/2001 | MY343949 | $500.00 | 1234 3344 8976 3456 | No |

The “Received” column is provided as a follow-up to indicate whether the rebate as promised by the member merchant has been received by the program operator or not.

In Step E, a merchant outlet record is maintained for each member merchant outlet. For a pre-determined time period or run of the program, a percentage of the total transaction value made by all members at this outlet is calculated and then debited against appropriate member merchant outlets. The member merchant outlets have to pay the program operator on that basis. This can be considered as the management fee of the loyalty program. An example of the merchant outlet record is illustrated below:—

| Item | Date | Merchant ID | Transaction Value | Loyalty No (s). | Received |
|---|---|---|---|---|---|
| 1 | 03/03/2001 | 1234567890 | $250.00 | 1234 4567 7891 1234 | Yes |
| 2 | 04/03/2001 | 2349865343 | $500.00 | 1234 3344 8976 3456 | No |

In Step F, a countercheck measure is provided. A master record is also maintained of the dates of transactions, the merchant outlet ID, the member (consumer) ID, the loyalty numbers generated in accordance with every transaction, rebates being paid or not. An example of the master transaction record is illustrated below:—

| Item | Date | Member ID | Merchants ID | Loyalty No (s). | Received |
|---|---|---|---|---|---|
| 1 | 03/03/2001 | 1234567890 | MY123456 | 1234 4567 7891 1234 | Yes |
| 2 | 04/03/2001 | 2349865343 | MY343949 | 1234 3344 8976 3456 | No |
| 3 | 05/03/2001 | 2389232382 | MY102102 | 1234 4567 7891 1236 | Yes |

Whenever a transaction is made, all three records are updated simultaneously, serving to counter-check one against the other.

In Step G, at least one potential reward recipient is randomly selected from a database of participating members. When the total quantum of loyalty numbers reaches a pre-determined number, the software program in the server will alert and notify the program operator. For an example, the target can be 1 million transactions, or total transaction value of $100 million dollars, or 1 million loyalty numbers, or a stipulated time period such as 30 days or a year.

The computerized loyalty program can randomly select one number as the potential reward recipient of a principal prize reward, or randomly select other number(s) as reward recipient(s) of other minor prize(s). Alternatively, a physical and manual ball-rop process is employed. It is important to note that the selection of the potential recipients is according to a tiered scheme. The tiered scheme includes a principal prize, and other minor prizes, in cash or in kind.

With a global network of member consumers and member merchant outlets, it is envisaged that as the program becomes more popular, a selection of a recipient for a million dollars reward is possible on a weekly or even daily basis.

In Step H, each potential recipient may be required to answer a quiz correctly before collecting the prize. This is an optional requirement.

Where a selection process signifies the end of a program according to pre-determined rules, all the loyalty numbers issued previously are rendered null and void. New set of loyalty numbers are issued in the subsequent program.

In Step I, where a few programs are run as a series according to pre-determined rules, all loyalty numbers issued are retained until the end of the series. Each number enjoys an opportunity to be included in all subsequent selection processes. Only at the end of the series, these loyalty numbers are rendered null and void. After the first selection process, all those previously issued loyalty numbers are carried forward to the next program. Only after the last selection process, all loyalty numbers are rendered null and void. Relevant member consumer records, member merchant outlet records and transaction records are then “emptied” accordingly.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A consumer loyalty marketing program based on multi-transaction platform that provides a high reward to members under a tiered reward scheme, involving electronic input means, a computer server, member consumers, member merchant outlets and a program operator, comprises the steps of:
registering a member consumer and creating a member record in a computer server;
registering a member merchant outlet and creating a member merchant record;
recording all transactions made by member consumers in a transaction record;
issuing loyalty numbers to member consumers following their individual levels of spending according to pre-determined rules of the program;
randomly selecting at least one potential reward recipient from a database of participating members, when a target is reached according to pre-determined rules of the program;
answering a quiz correctly to claim and receive the rewards from the tiered reward scheme on an optional basis; and
updating all records therein the computer server after each selection of the program.

2. A consumer loyalty marketing program as in claim 1 in which the issuance of loyalty numbers follows certain pre-determined rules of the program.

3. A consumer loyalty marketing program as in claim 1 or 2 in which one or more loyalty numbers are randomly selected by the computer, as the potential reward recipients for each program, according to pre-determined rules of the program.

4. A consumer loyalty marketing program as in claim 1 or 2 in which one or more loyalty numbers are manually and randomly selected, as the potential reward recipients for each program, according to pre-determined rules of the program.

5. A consumer loyalty marketing program as in claim 1 in which the program is operated electronically on a global basis.

6. A consumer loyalty marketing program as in claim 1 in which a computerized member consumer record includes at least loyalty numbers issued for each qualified transaction;
a computerized member merchant outlet record includes agreed rebates after each qualified transaction;
a master record of all transactions,
whereas all three records are used as a countercheck measure against one another.

7. A consumer loyalty marketing program as in claim 1 in which a few programs can be run in a series according to pre-determined rules, while all previously issued loyalty numbers are considered for subsequent selection process of potential reward recipients until the end of the series, and all such numbers are rendered null and void at the end of the series.

8. A consumer loyalty marketing program as in claim 1 in which all previously issued loyalty numbers are rendered null and void, where the selection process signifies the end of a program according to pre-determined rules of the program.
